(19) United States
(12) Patent Application Publication
(10) Pub. No.: US 2006/0106645 A1
(43) Pub. Date: May 18, 2006

(54) System and methods for tracking medical encounters

(75) Inventors: Michael N. Bergelson, Bronx, NY (US); Andreas H. Theodosiou, Lexington, MA (US)

Correspondence Address: HOUSTON ELISEEVA, 4 MILITIA DRIVE, SUITE 4, LEXINGTON, MA, 02421, US

(73) Assignee: ADHD Systems, LLC, New York, NY (US)

(21) Appl. No.: 10/991,351

(22) Filed: Nov. 17, 2004

(51) Int. Cl. G06F 19/00

(52) U.S. Cl. 705/3

(57) ABSTRACT

A method for tracking a patient's medical encounters includes storing a record identifying the patient in a database, receiving notification of a medical encounter between the patient and a healthcare provider, adding encounter information to the record to generate an updated record, and storing the updated record. The method also includes reporting the encounter information to the patient or to an authorized third party. A business method and system for tracking a patient's medical encounters also are disclosed.

### BACKGROUND OF THE INVENTION

As health care becomes more complex and expands, information about a patient's treatment and medical encounters also expands, encompassing a multitude of professionals and institutions. Health care providers are now required to treat a greater number of patients, perform more tests and analyze more information than was required before. General practitioners refer patients to a wider variety of specialists who rely on more clinical testing. Typically, each care provider maintains its own file(s) on the patient.

To reduce the probability of errors physicians often need access to information regarding a patient's medical history. For example, a specialist may need to know the identities of other specialists consulted by the patient in the past, dates of prior hospital stays and/or prior medical tests, the names and locations of healthcare institutions previously involved in the patient's health care and other information.

It is known that insurance companies keep patient records in order to provide proper payment for health care providers. It is also known that general practitioners often monitor treatment by specialists (cardiologists, therapists, etc), where they direct patients to apply for additional care.

Nevertheless, obtaining an overall medical history for a particular patient is not an easy task, and the care provider often must rely on the patient's memory. Since over the years the patient may have visited more than one general physician, specialist, medical laboratory or hospital, and may have had medical coverage with more than one insurer, the patient's recollections may be incomplete and/or unreliable. In many cases, the healthcare provider must personally undertake cumbersome and time consuming investigations to track down information regarding the patient's prior medical encounters. In some situations, a healthcare provider may run into the opposite problem and receive overwhelming amounts of information regarding specific episode(s) in the patient's past healthcare, which may have little relevance to the patient's current condition.

The difficulties and uncertainties associated with obtaining a patient's medical history potentially reduce the quality of care and increase its costs. Accumulation, systematization and analysis of extensive amounts of information, not always relevant, add to the time, effort and cost of treating individual patients.

Attempts to ease the administrative effort in having access to patient data include several types of computerized systems that have been developed to maintain patient electronic records. Examples of existing systems include: hospital information systems; specialized patient follow-up systems for physician practices; scheduling systems; practice office management systems; and systems related to insurance coverage and bill payments.

Efforts for creating information technology that serves the purpose of accumulating information about patients in one location, usually in a computer center, also have resulted in a multitude of systems. The Health Information Systems within hospitals and other large medical institution, for instance, relies on computers and electronic communications.

Vendors such as Medicalogic, Epic, IDX, GEMS, Medtronic Paceart and others have developed commercial systems for within a hospital or medical practice use and some provide patient access to information on the Internet: Web Access.

One specific illustration of a system for providing automated, electronic communications between a physician and a plurality of users (e.g., patients) of the health-care provider is disclosed in U.S. Pat. No. 6,757,898, issued to Ilsen et al. on Jun. 29, 2004. The system includes a central server, a provider's service computer and a plurality of users' computers. At its core is a fully automated mechanism for generating a patient page for each user within the doctor's or health care group's web site within the system.

The system disclosed in the patent assumes that both the patient and the healthcare provider have equipment capable of communicating with the service. Like many other existing systems, the one disclosed in U.S. Pat. No. 6,757,898 does not address the needs of those small or individual medical practices that maintain paper copies of test results and patient interviews and lack the equipment, technical know-how, time and/or resources for converting to a compatible electronic format, nor does the system help patients that do not own equipment suitable for Web Access.

Even with the proper equipment, a patient only has access to information gathered by those health-care providers that are members of the system, resulting in potential gaps and uncertainties when attempting to reconstruct a patient's overall medical history. In addition, the system disclosed in U.S. Pat. No. 6,757,898 provides a physician with large amounts of information; its thorough review may be cumbersome or impossible, given the increasingly severe constraints on physician time. Moreover, the need for converting large amounts of information to an electronic format renders its implementation economically unattractive.

A need therefore exists for a simplified and cost effective system and method for recording the history of a patient's medical encounters that reduces or minimizes the problems described above. Specifically, there exists a need for an overall, reliable methodology for tracing a patient's path through several physicians in an environment when a patient may attend many physicians of different specialties at different times.

### SUMMARY OF THE INVENTION

The invention generally relates to a method, system and business method for tracking a patient's medical encounters.

In one embodiment, the invention is directed to a method for compiling a patient's medical history. The method includes updating a patient database record upon notification of the patient's encounter with a healthcare provider to add the date of the encounter and identity of the healthcare provider. The updated record is stored. As the record is updated with each medical encounter, over time, the record reflects the history of the patient's medical encounters.

In another embodiment, the invention is directed to a method for tracking a patient's medical encounters. The method includes storing a record identifying the patient in a database. Upon notification of a medical encounter between the patient and a healthcare provider, the record is updated to add encounter information. The updated record is stored, thereby tracking the patient's medical encounters. A report indicating encounter information is released to the patient.

In a further embodiment, the invention is directed to a system for tracking a patient's medical encounters. The system includes a database record identifying the patient, a first interface providing web access for receiving notification of the patient's medical encounter with a healthcare provider and a second interface providing telephone network access for receiving notification of the patient's encounter with a healthcare provider. The system also includes a processing unit for finding and updating the database record upon receiving notification from either interface to indicate encounter information and an output processing unit for presenting or communicating encounter information.

In yet another embodiment, the invention is directed to a business method for tracking medical encounters. The business method includes populating a database with at least one patient's record, receiving notification of the patient's medical encounter with a healthcare provider and updating the record to add the date of the encounter and the identity of the healthcare provider. The updated record is stored. In a preferred implementation, a report indicating encounter information is released to the patient or an authorized third party.

In some embodiments, a patient identification code and encounter information are received via the internet, using radiofrequency identification or bar code technology. In other embodiments the code and encounter information are received via a public telephone network, for example by means of a trans-telephonic transmitter.

The invention puts the patient in charge of his or her own healthcare. It provides a simple, reliable service for tracking a patient's medical encounters, e.g., visits with general practitioners, specialists, clinical tests, hospital stays and other medical events. A patient subscribing to the service disclosed herein is free to change caregivers, move from one state or country to another, effect changes in insurance coverage or healthcare plans without needing to remember or record prior medical events. Because of flexibility in accessing the system, a patient who uses the invention does not have to ascertain whether a doctor participates in the service or is connected to the system.

Using the invention, subscribing patients can present a treating healthcare provider with an overview or summary of their prior medical encounters. From this, the healthcare provider can select and pursue leads relevant to the present condition being treated. Review and analysis of vast amounts of medical records and medical data is minimized or eliminated.

Physicians who participate in creating the history of a patient's visits can but do not have to subscribe to the service disclosed herein. A healthcare provider can install equipment for accessing machine-readable codes such as reading a bar coded or radio-frequency identification (RFID) card carried by the patient without being required to send or store medical information on the system. Thus the need for data conversion and data uniformity among healthcare providers is eliminated.

To practice the invention, neither the healthcare provider nor the patient must own a computer or have access to a communication network. Thus implementation of the invention does not require building an infrastructure necessary for “automatic data transfer” to the patient's computer. Rather, it builds on existing technology and existing communications infrastructure. Nevertheless, implementations of the invention contribute to the steady increase in the effectiveness of a computerized approach in the field of electronic medical record keeping (EMR).

In one aspect, practicing the invention is particularly advantageous to multi-pet or farm animal owners who can use the invention to record and store encounters with veterinarians and other animal caregivers.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic view showing the functional relationships among components of one embodiment of the invention.

FIG. 2 is an illustration of a report showing a patient's medical visits.

FIG. 3 is a schematic illustration showing the generation of a history of visits to caregivers.

FIG. 4 is a schematic view showing functional relationships among components of one embodiment of the invention.

FIG. 5 is a schematic view showing access and functional relationships among components of one embodiment of the invention.

FIG. 6 is a schematic diagram of a transmitter that can be used to access the system in one embodiment of the invention.

FIG. 7 is a schematic diagram of equipment that can be used to access the system in one embodiment of the invention.

FIG. 8 is an illustration of one example of a patient card that uses radiofrequency identification (RFID) technology.

FIG. 9 is a schematic diagram showing equipment that can be employed to access the system using RFID technology.

FIG. 10 is a schematic view showing functional relationships among components of one embodiment of the invention showing access to the system using RFID technology.

FIG. 11 is a schematic view showing functional relationships among components of one embodiment of the invention showing access to the system using RFID technology together with access to the system using a public telephone network.

FIG. 12 is a graphic illustration of an example of telephone access and communication with the system.

### DETAILED DESCRIPTION OF THE PREFERRED EMBODIMENTS

The invention generally relates to a method, a system, and a business method for tracking medical encounters. Practicing the invention results in a recordation of the date of each encounter and identifies the healthcare provider involved. Over time, an overall history of the patient's medical events is generated and maintained.

Examples of medical encounters include visits to medical laboratories, office visits to general physicians and specialists, surgeries, hospital stays, clinical tests, treatment regimens and other medical events. As used herein, the term “medical encounter” also can refers to visits to physical therapists, dietitians, podiatrists, chiropractors, acupuncture practitioners, optometrists, dentists, mental health professionals, drug or alcohol abuse therapies and other health-related encounters.

Prescription drug procurements also can be included.

In other implementations of the invention, the term “medical encounter” refers to animal healthcare encounters such as, for example, visits to or by veterinarians, visits or stays in animal clinics or hospitals, animal surgeries, vaccinations, etc.

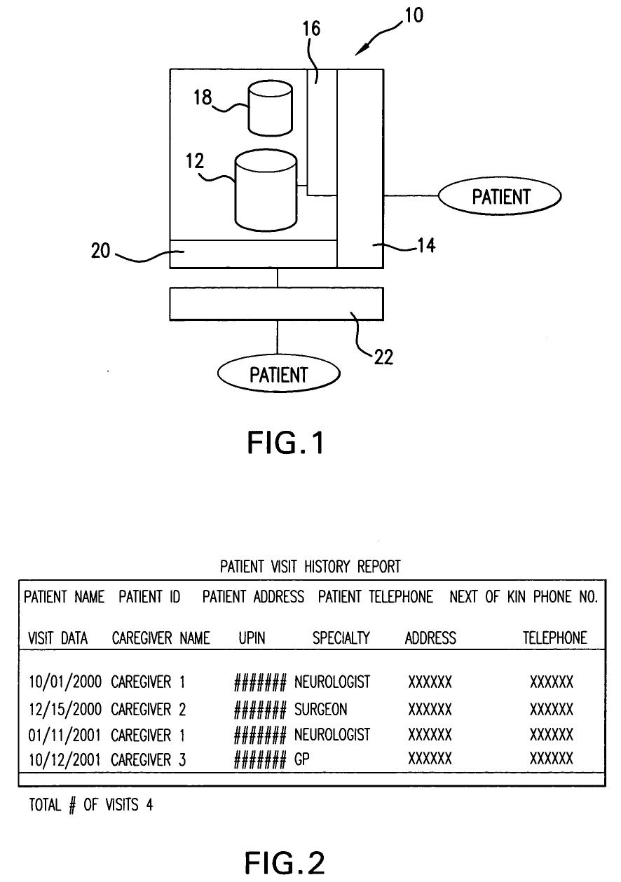

Shown in FIG. 1 is system 10 that can be employed to track a patient's medical encounters. As used herein, the terms “patient” refers to a human or animal healthcare recipient.

System 10 includes patient database 12 which resides on a server.

The database is produced as known in the art, for instance by entering data using a suitable commercial software package. In one example, a structured query language (SQL) database engine is used.

Database 12 includes at least one patient record. The record generally is created during the enrollment process. To enroll or subscribe, a patient can complete an application and forward it to personnel, business or service organization associated with system 10. A patient also can enroll via the internet, by telephone, through a service representative, a broker or by other suitable methods.

The record identifies the patient, by a unique patient identification code, for instance a randomly generated numerical or alphanumerical sequence, a patient's social security number, a number generated by an insurer, a healthcare provider or by another system handling patient data. The length and other characteristics of the identification code can be selected based on the database architecture and/or software.

Preferably, the record also includes demographic information, e.g., the patient's name, address, telephone number, age, sex, emergency telephone number(s) and/or next of kin information. Other relevant data regarding the patient, such as, for example, historical data for the period preceding enrollment in the system, lists of prior healthcare providers visited, allergies, vaccination status, chronic conditions, prescription and/or over-the-counter medication, insurance-related information, conditions for releasing patient information to a third party or for excluding such a release, authorization for releasing medical encounter information to one or more specific healthcare providers, the patient's identification at specific healthcare providers or insurers and other data, also can be included.

In one embodiment, all the information related to one patient identification code is included within one record and data can be added to fields in the patient record, as known in the art. In another embodiment, several records are linked to one patient through the patient identification number. In the preferred embodiments, database 12 includes records for a plurality of subscribing patients.

System 10 also includes interface 14. Interface 14 facilitates access and communication between the user and system 10 and can use an interface processor, as known in the art. For instance, interface 14 receives a patient's identification code and other information, for instance notification of a medical encounter, notification of an appointment for a medical encounter, a cancellation of a planned medical encounter, notification of a treatment start-up date, clinical test, follow-up medical visit and other encounters. Interface 14 also can be employed to respond, for example by indicating validation of a patient's identification code or completion of communication between the patient and the system.

Interface 14 can be provided with or made compatible with communication devices, equipment, software, protocols for various modes of accessing the system, as further disclosed below. Examples include modems, internet links, or other data communication devices or systems.

Also included in system 10 is processing unit 16 for finding and updating the patient record to indicate the information received by interface 14.

The patient record is updated to indicate a medical encounter. Encounter information generally is added to the record and stored in the database. As used herein, the term “encounter information” usually comprises the date of the encounter (scheduled or completed) and identity of the healthcare provider. Encounter information can also include the specialty field of the healthcare provider and further information, regarding the healthcare provider's practice.

In some embodiments, notification of a scheduled encounter can include less information, for example the date and the medical field for the anticipated visit; the identity of the healthcare provider is supplied at a later time, for instance at the time of the encounter. In a preferred embodiment, upon receipt of the patient's identification code, the entire medical information added to the record is encounter information.

Information regarding previous medical encounters generally is maintained in the record or database, thereby representing a compilation of the patient's medical history. In some implementations, data other than “encounter information” can be provided. For instance, medical data can be added to the same or to a linked database.

Specifically, processing unit 16 uses the patient identification code received via interface 14 to search database 12, to find the patient record(s) and to enter the date of the patient's latest medical encounter and to identify the healthcare provider.

As used herein, the term “healthcare provider” refers to physicians, institutions and other caregivers taking part in the patient's health care. Examples of healthcare providers include general physicians, specialists, medical laboratories, clinics or hospitals. Healthcare providers also can include physical therapists, podiatrists, chiropractors, acupuncture practitioners, dentists, optometrists, mental health professionals, drug or alcohol abuse therapists, nurses, HMOs and other health-related personnel. In one implementation of the invention, healthcare providers include veterinary doctors, animal clinics, animal hospitals and others animal health caregivers.

Many U.S. healthcare providers are uniquely identified, for instance, by a unique physician identification number (UPIN), or by a universal provider identification number (UPIN). UPIN designations are widely used. An example of a database that includes these identifications numbers as well as corresponding contact information can be found at http://upin.ecare.com/.

System 10 includes optional UPIN database 18 for storing UPIN lists, e.g., a copy of the UPIN database found at the above-referenced web site. A routine or protocol is installed for accessing UPIN database 18 and importing the identity of the healthcare provider into the patient record. For example, the routine or protocol can use the UPIN corresponding to the healthcare provider to import the healthcare provider's UPIN, the contact information and field of specialization into the patient record. In another example, contact information of the caregiver is used to search UPIN database 18 to find the UPIN number and import it into the record.

In other embodiments of the invention, the system includes a link for accessing and searching a UPIN database via the internet or a UPIN database stored on another server, connected, for instance, by a local or wide area network.

In the absence of a UPIN, a healthcare provider can be identified in a different manner, for example by the name, address, telephone number. The field of specialization of the healthcare provider also can be included.

Data in a record can be changed at any time to correct errors or update the patient's contact information, or other information such as vaccination status, next of kin, insurance information, medication course, etc. An appointment for a medical encounter can be changed to indicate a completed medical encounter. The record also can be changed to delete an appointment that was not kept. Thus interface 14 and processing unit 16 optionally are capable of receiving and adding other information to the patient record(s) or for effecting changes or corrections in the patient record.

The system further includes output processing unit 20 for accessing and for processing encounter-related information for output communication or presentation, for instance in the form of a report. Output processing unit 20 can include or be provided with communication to one or more printers, facsimile machines, internet connections and other equipment.

Output communication or presentation can be on-demand, periodic, according to a pre-determined schedule, e.g., monthly, or both. The generation of a report also can be triggered by notification of a scheduled and/or completed medical encounter. In one implementation of the invention, the report is generated on the premises of the healthcare provider, upon the patient's arrival for a medical encounter. If desired, a report can be generated without the trigger of a medical encounter. Thus a monthly report can show that no encounter has occurred during the relevant period.

In a preferred embodiment of the invention, the report generated by output processing unit 20 indicates encounter information, i.e., specifies the date of the encounter and identifies the healthcare provider. As discussed above, a healthcare provider is identified by one or more of the following: UPIN, name, contact information, e.g., address, telephone numbers, facsimile number, field of specialization, etc.

Information regarding more than one encounter can be included in the report. In some embodiments, the report lists the latest medical encounter together with previous medical encounters.

Optionally, the report lists the patient identification code and/or the patient's name and contact information. Next of kin, allergies, chronic conditions, vaccination status, ongoing treatments or medication, insurance status and other information in the patient record also can be included. An illustration of a report generated by output processing unit 20 is shown schematically in FIG. 2.

Generally the report is released to the patient. In some cases, the report, or a copy of the report, is released to an authorized third party. As used herein, the term “authorized third party” refers to parents or guardians using the system on behalf of a child or charge and to pet or animal owners using the invention for tracking an animal's health related encounters. The term “authorized third party” also refers to persons and institutions, such as, for instance, nursing homes, next of kin, healthcare providers and others, authorized by the patient to receive the report.

In one embodiment of the invention, the authorized third party is not a subscriber in the service associated with the system described herein. In other embodiments, subscribing authorized third parties can receive the report automatically. For example, a subscribing general practitioner can be authorized by one or more of his or her patients to receive reports tracking the patients' medical encounters. Thus a subscribing general practitioner can directly monitor the patients' visits with specialists, clinical tests, therapies, and other medical events.

In some implementations of the invention, a subscribing authorized third party also can access the patient record directly, using the patient identification code. In one example, the system and method of the invention include an authorization validation routine or protocol to determine that a particular healthcare provider is authorized to access a particular patient's record. Once the determination is completed favorably, the healthcare provider can access the patient's record via the patient identification code or via other information specific to the patient, for instance the patient's contact information. The subscribing authorized third party can provide information regarding medical encounters or request changes or corrections to the patient record.

The report can be in paper form and its delivery 22 can be via postal service, document shipping carriers, e.g., UPS, FedEx or other carriers or couriers. In other instances, the output is delivered via facsimile. In yet other implementations of the invention, the report is presented in electronic format and can be electronically mailed to a patient's electronic mail address, or viewed using the patient's identification code by web access to the system. If desired, the report can be saved on a removable media, e.g., a diskette, CD, etc., for transfer and/or viewing on a personal computer. The report also can be provided orally, for instance over the telephone, by a staff member or by an automated system that can be accessed using the patient identification code.

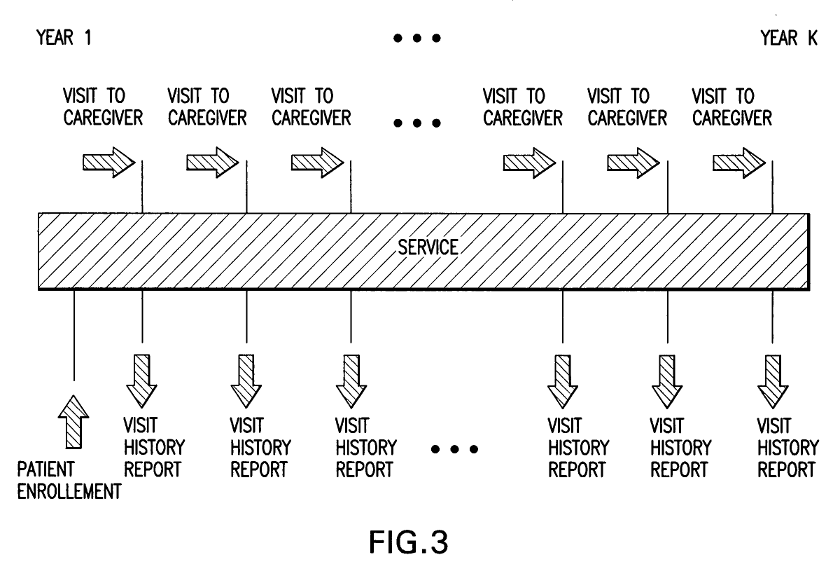

Over time, a patient's record is updated with medical encounter information which is stored in database 12, tracking the patient's medical history. An example of a medical history that can be generated is illustrated schematically in FIG. 3. As seen in this figure, once a patient is enrolled in the service, each of his or her visits to a healthcare provider is recorded in the system and a report is generated after each visit. Over time, specifically through year K, the system generates an overview of all the patient's medical encounters.

Upon visiting a caregiver, the patient can present the report showing the patient's medical history. From the report, the healthcare provider can select those prior medical encounters that have relevance to the patient's current condition or complaint and can obtain additional information, e.g., medical records, regarding the selected encounters.

In one embodiment, the system is used to track encounters with veterinary doctors and other animal caregivers. A record identifying a companion, farm or rescued animal can be updated to indicate an encounter with an animal healthcare provider, essentially as described herein. In one implementation, chip technology currently used for identifying lost animals can be employed to identify a pet or another animal in the system. Over time, the system compiles the history of encounters involving the animal and makes it available to the animal owner or an authorized animal caregiver.

Several approaches can be employed to access the system disclosed herein.

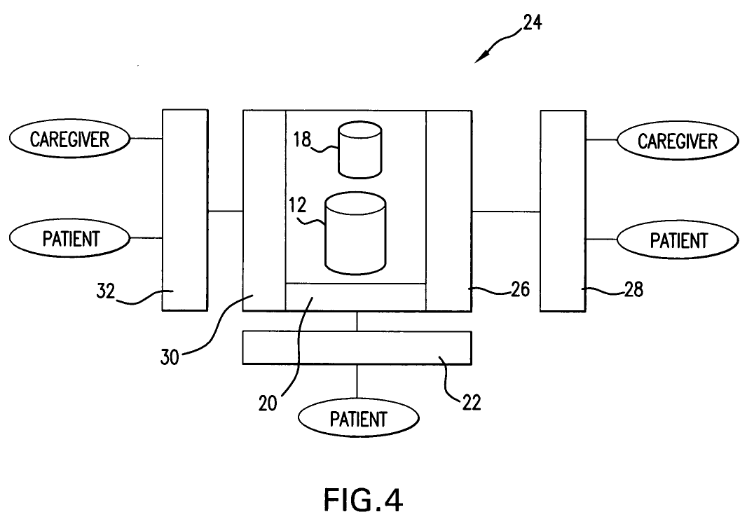

Shown in FIG. 4, for example, is system 24 which includes patient database 12 and optional UPIN database 18, essentially as described above. System 24 also includes report generation unit 20. Reports are generated and delivered essentially as described above.

System 24 includes an interface processor, specifically web interface 26 for accessing and updating a patient record via internet connection 28.

Internet-based communication software and hardware that can be employed for accessing database 12 are known in the art.

As already described, the record is accessed and/or updated via the patient identification code, by the patient or a care giver, who is an authorized third party.

System 24 also includes telephonic interface 30, for access and via public switching telephone network 32.

Telephone interface 30 includes, or can be connected to, modems and other suitable communication hardware and can utilize software and computer routines or protocols, as known in the art.

As discussed above, database 12 is accessed using the patient identification code. For example, the patient places a telephone call to a telephone number assigned to the service associated with system 24. A person or an automated response system receives and validates the patient identification code. The patient provides information regarding a scheduled or completed medical encounter and identifies the healthcare provider by UPIN, if known by the patient, or by providing the healthcare provider's name and contact information. The patient record is updated to indicate the medical encounter, essentially as described above. This mode of accessing system 24 does not require the use a computer.

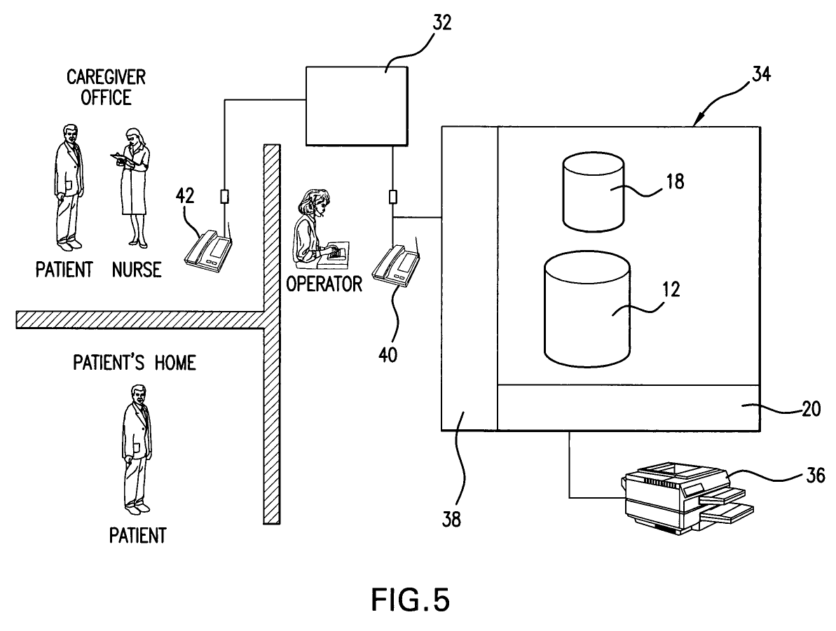

One embodiment of accessing the system via a public switching telephone network is illustrated in FIG. 5. Shown in FIG. 5 is system 34 which includes patient database 12, optional UPIN database 18, report generating unit 20 connected to printer 36, essentially as described above. System 34 also includes interactive voice response (IVR) 38 that is accessed via public switching telephone network 32 and, optionally, through an operator associated with system 34.

A patient can dial the telephone number of telephone unit 40, associated with system 34, using a home telephone or telephone set 42 in a care giver's office, either directly or through an authorized intermediary, e.g., a nurse. Optionally, the healthcare provider's UPIN is provided, for instance by obtaining this information from personnel in the caregiver's office. Database 12 is updated to indicate encounter information in the patient record, essentially as described above.

For an automated and private transfer of the patient's identification code to the system, a patient can be provided with a trans-telephonic transmitter (TT). A suitable TT that can be employed is a CarryAll™ manufactured by Instromedix, a Card Guard Company; further information can be found at http://www.instromedix.com/pacemaker_monitors.htm. Other suitable TTs also can be used.

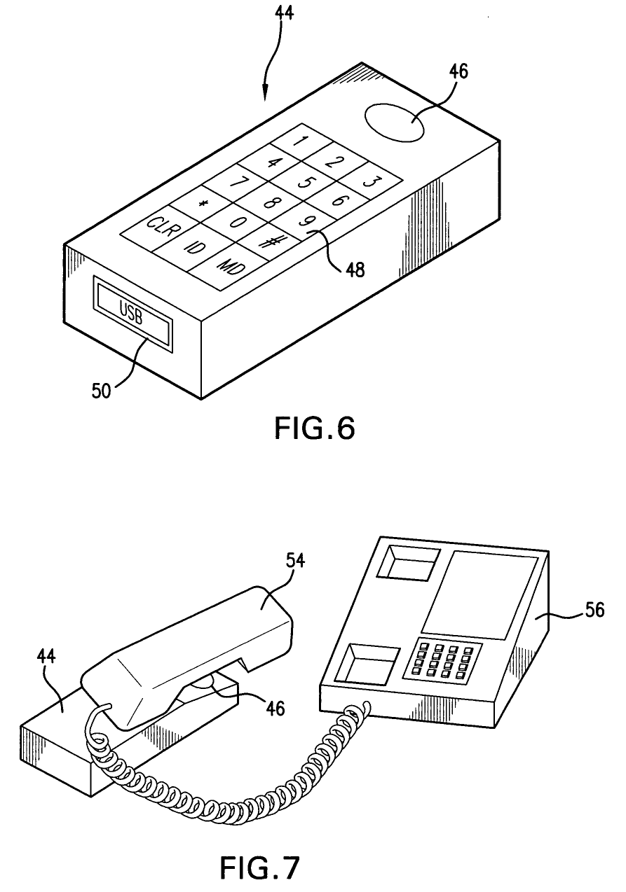

Shown in FIG. 6 is transmitter 44, which includes speaker 46, keyboard 48 and universal serial bus (USB) receptacle 50. Transmitter 44 is programmed to include the patient identification code and optionally, other information regarding the patient. Contact information and/or confidential information can be included. In one embodiment, transmitter 44 is programmed by connecting it to the patient database and encoding the information.

The patient can enter a healthcare provider's UPIN and/or telephone number using keyboard 48 into the memory of transmitter 44. Other information, for example the date of the encounter also can be entered. Information transfer occurs when the patient places a call to the service associated with the system of the invention and responds to commands of an operator or IVR.

To use the trans-telephonic transmitter, the patient places handset 54 of telephone 56 over speaker 46 of transmitter 44, as shown in FIG. 7, then presses an ID button on keyboard 48 to start transmission and to forward the patient's identification code and other information entered via the keyboard to the system, thereby updating the patient's record in the database. In one embodiment, the system enters the date and time of the encounter automatically, based on the time that transmission is received. Upon finishing the transfer, the patient hangs up the telephone.

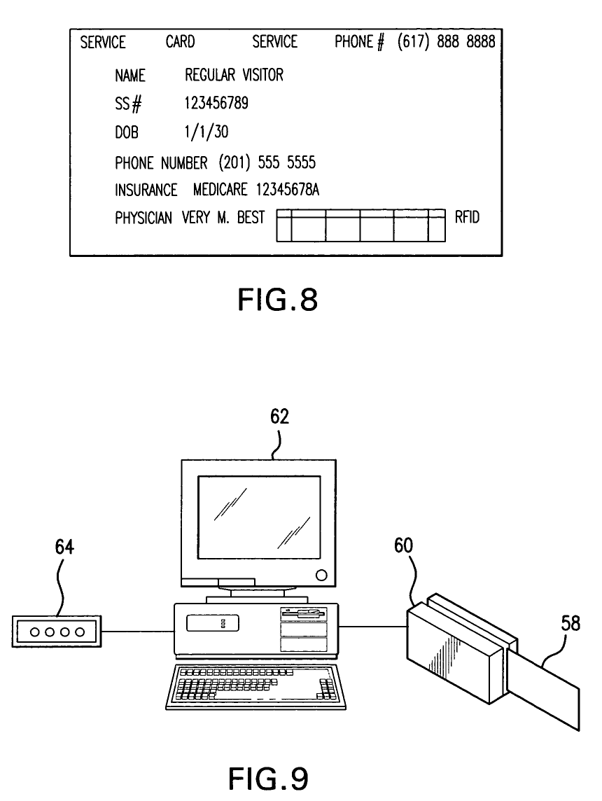

In a preferred implementation of the invention, a card indicating the patient's identification code and other patient information, such as described above, is issued to the patient at or following enrollment. One example of such a card is shown in FIG. 8. Optionally, the card can also include, for example on the back of the card, the patient's authorization for storing medical information on the system disclosed herein, authorization for releasing the information, the patient's signature or other information.

The patient identification code and, optionally, other information, are stored on the card utilizing bar coding or radiofrequency identification (RFID) technology. In one implementation, data encoded is encrypted to ensure privacy, confidentiality and security. Methods for encrypting data are known in the art.

RFID technology for monitoring mobile patient care plans is disclosed in U.S. Published Patent Application No. 2004/0153344 A1, by Bui et al., published on Aug. 5, 2004, the entire teachings of which are incorporated herein by reference. Examples of RFID technology that can be employed include strips, “smart labels” or “smart tags” such as Omron's V720 Series inlets and tags or Tag-it™, products from Texas Instrument Radio Frequency Identification Systems, and others.

Generally, RFID tags include a transponder that allows for communication with the RFID tag. RFID tags employ transponders having various read and write functionality. For example, a transponder may be read only (R/O), read/write (R/W) or write once/read many (WORM). Further, transponders used on RFID tags have varying power sources. For instance, an active transponder is equipped with battery power, thereby providing greater reading distances while a passive transponder is powered by the RF energy emitted from a reader or interrogator, thereby providing for lower costs.

Transponders may operate at different frequency ranges. For example, a low frequency transponder may operate at about 125 kHz with a read range of about 10 cm while a high frequency transponder operates at about 13.56 MHz with a read range of about 1 m to about 5 m. Further, a transponder may even operate at an ultra high frequency within the range of 433-915 MHz and 2.45 GHz with a read range from about 3 m to about 20 m under FCC regulations.

FIG. 9 illustrates accessing the system of the invention using RFID technology. As shown in FIG. 9, patient card 58, provided with RFID encoding the patient identification code, is read by card reader 60 and the information is transmitted to a computer, for instance personal computer 62. Devices capable of reading information on the RFID tag include reader or interrogator such as the Hand'IT™ contactless reader manufactured by Inside Technologies, and others. A bar coded card also can be employed, in conjunction with a suitable barcode reader, as known in the art.

Communication with the system for updating the patient record to indicate encounter information can be provided using internet connection 64. Other suitable communication networks can be utilized, for instance a medical or hospital intranet.

The transmission and downloading of information to and from the RFID tag on patient card 58 can be via one or more transceivers, as known in the art. In one embodiment, the transmission and/or reception of information is accomplished using infrared technology using an infrared transceiver and a communication network that is equipped with a corresponding infrared transceiver. Other methods of communication include wireless communication such as IEEE 802.11, BLUETOOTH^{RTM} communication, radio frequency communication, optical communication, and the like.

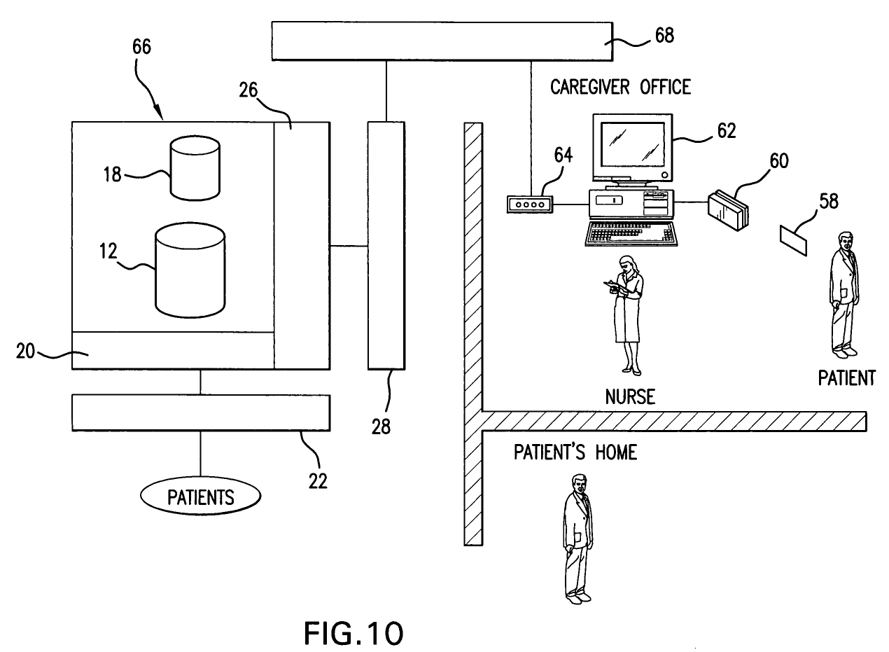

Accessing the system from the premises of a healthcare provider, equipped with an RFID card reader is illustrated in FIG. 10. FIG. 10 shows system 66 which includes patient database 12, optional UPIN database 18, web interface 26 and internet connection 28, together with report generating unit 20. Also shown in FIG. 10 is computer 62, e.g., a personal computer, having internet connection 64. Computer 62 resides is in a caregiver's office and can be connected to system 66 via internet infrastructure 68. The caregiver does not need to be a subscriber of the service and is not required to transfer patient medical records to system 66. Rather, the caregiver provides RFID card reader 60 that is capable of reading the patient's RFID or bar coded card 58. RFID card reader 60 is connected to computer 62.

In one example, upon arrival for a medical encounter, the patient presents his or her RFID card, for instance to a nurse in the caregiver's office. The card is read by card reader 60. The patient's identification code is transferred to system 66, together with any additional information, thereby accessing and updating the patient's record in database 12 to indicate encounter information. In due course, a report indicating the medical encounter is generated and released via delivery 22, essentially as described above.

In another example, the patient's RFID card is read by card reader 60. The patient's identification code is transferred to system 66, together with any additional information, thereby accessing the patient's record. A report showing the patient's prior medical encounters is requested, using, for instance, computer 62 and routines or protocols for generating on-demand reports, available within system 66. In other implementations, the request for an on-demand report is encoded on the patient's RFID card and is transmitted to system 66 together with the patient's identification code.

The report is in a format suitable for review by the healthcare provider prior to or during the medical encounter. For instance, the report can be in electronic format for viewing and/or printing via an office computer, such as computer 62. In another example, the report is directed to a facsimile machine in the caregiver's office.

A healthcare provider who does not have a computer system and/or internet connection can employ a public switching telephone network and a card reader connected to a modem to provide encounter information to the system.

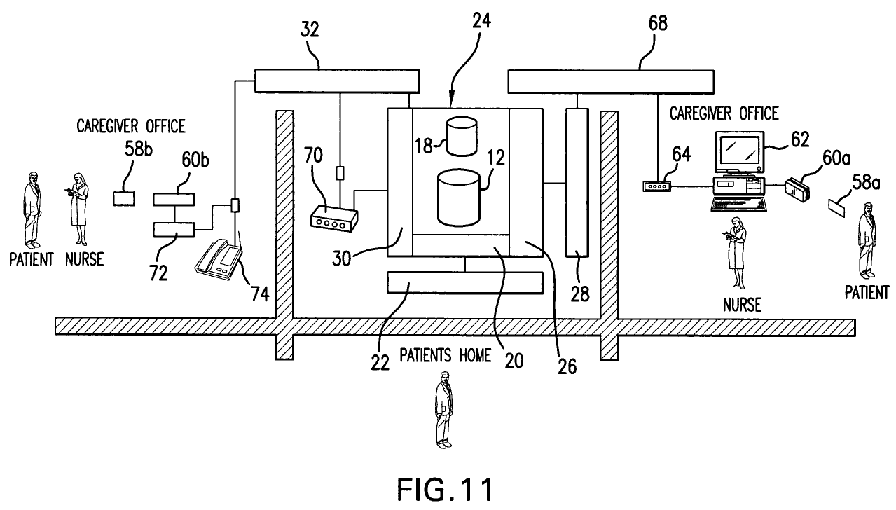

The flexibility in accessing the system from the premises of a healthcare provider is illustrated in FIG. 11. Shown in FIG. 11 is system 24 essentially as described with respect to FIG. 4. System 24 has web interface 26 and internet connection 28, as well as a telephone interface 30, for connecting system 24, via service modem 70 to public switching telephone network 32.

In the case of a caregiver that has a card reader and a computer system, such as described above, access to system 24 can be obtained from the caregiver's office, via internet infrastructure 68, essentially as described above. Specifically, patient RFID card 58a is presented by a patient visiting the office and is read by RFID card reader 60a. Card reader 60a is connected to internet infrastructure 68 via personal computer 62, which is provided with internet connection 64. A barcoded card and barcode reader device also can be employed.

System 24 also can be accessed from the premises of a healthcare provider who does not have a computer and/or internet access. Specifically, a patient arriving for a medical encounter presents his or her patient RFID card 58b, which is inserted into card reader 60b. Card reader 60b decodes the information from the card and transfers it to transtelephonic encoding device 72. Transtelephonic encoding device 72 is connected to telephone receptacle 74. Access to system 24 is established via public switching telephone network 32.

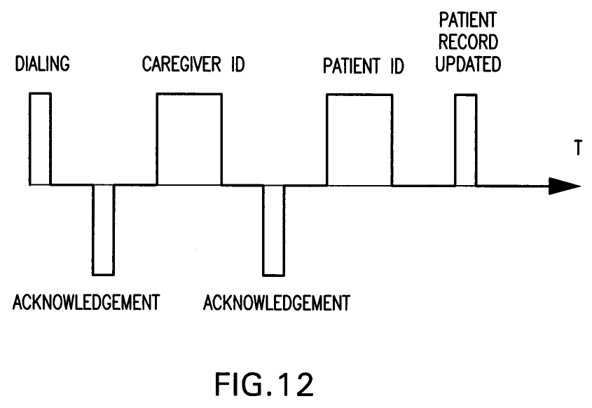

One example of a sequence of signals received by system 24, via public switching telephone network 32, is shown schematically in FIG. 12. Specifically, system 24 acknowledges dialing to indicate that connection with modem 70 has been established. Further information identifying the healthcare provider is then supplied to system 24. An acknowledgement is sent back to telephonic encoding device 72, to confirm that the caregiver is a participant in the service and/or has a UPIN. The patient identification code, read from the RFID card 58b by RFID card reader 60b is then forwarded to system 24. The corresponding patient record in database 12 is accessed and updated to indicate the medical encounter, essentially as described above. Transtelephonic encoding device 72 gives a visual or auditory signal to indicate the successful completion of the transaction. In further embodiments, tanstelephonic encoding device 72 also can provide error messages and, optionally, recommendations for remedial actions.

A report that indicates the medical encounter is generated and delivered to the patient, essentially as described above.

The invention also relates to a business method for tracking medical encounters. The method includes populating a database with patient records. As described above, a patient is identified in the database by a unique patient identification code. Patient records also can include demographic information and other information such as a patient's allergies, vaccination status, etc.

The records are updated to add medical encounter information and the medical encounter information is stored in the database.

Reports indicating medical encounter information are provided, essentially as described above. In one implementation, reporting is to patients. In another implementation, the business method includes releasing a report that indicates one or more medical encounters to an authorized third party, for example a hospital involved in the recipient's care, a nursing home, next of kin, etc. If authorized by the patient, a subscribing healthcare provider can receive the report automatically. Once authorized, a subscribing general practitioner, for example, can obtain reports tracking his or her patients' visits to specialists, clinical laboratories and other care givers.

In one embodiment, the business method further includes supplying healthcare providers with card readers capable of reading patient identification cards that use bar-coding or RFID technology, essentially as described above.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for tracking a patient's medical encounters, comprising:
a. storing a record identifying the patient in a database;
b. receiving notification of a medical encounter between the patient and a healthcare provider;
b. adding encounter information to the record to generate an updated record;
c. storing the updated record, thereby tracking the patient's medical encounters; and
d. reporting the encounter information to the patient or to an authorized third party.

2. The method of claim 1, wherein the record includes patient demographic information.

3. The method of claim 1, wherein the record includes information regarding at least one prior medical encounter.

4. The method of claim 1, wherein receiving notification includes radiofrequency identification.

5. The method of claim 1, wherein receiving notification includes bar coding identification.

6. The method of claim 1, wherein receiving notification includes interactive voice response.

7. The method of claim 1, wherein encounter information includes a unique physician identification number (UPIN) or a universal provider identification number (UPIN).

8. The method of claim 1, wherein the encounter information is reported via the internet.

9. The method of claim 1, wherein the encounter information is reported via a printed report.

10. The method of claim 1, further comprising encoding the patient's identification code in a trans-telephonic transmitter.

11. The method of claim 1, further comprising encoding the patient identification code on a radiofrequency identification card.

12. A method for compiling a patient's medical encounter history, comprising:
a. updating a patient database record upon notification of the patient's encounter with a healthcare provider, to add the encounter date and identify of the healthcare provider; and
b. storing the encounter date and identity of the healthcare provider in the database.

13. A system for tracking a patient's medical encounters, comprising:
a. a database record identifying the patient;
b. a first interface providing web access for receiving notification of the patient's encounter with a healthcare provider;
c. a second interface providing telephone network access for receiving notification of the patient's encounter with a healthcare provider;
d. a processing unit for finding and updating the database record upon receiving notification from either or both of the first and second interface to indicate encounter information; and
e. an output processing unit for presenting or communicating the encounter information.

14. A system for tracking a patient's medical encounters, comprising:
a. a database for maintaining patient records;
b. a first interface capable of receiving patient radiofrequency identification and medical encounter information;
c. a second interface capable of receiving patient trans-telephonic transmitter identification and medical encounter information;
d. a unit linked to the first and second interface for processing a patient's identification to find the patient's record and to add the patient's medical encounter information to said record; and
e. an output processing unit for presenting or communicating the medical encounter information.

15. The system of claim 14, further comprising a UPIN database for identifying a healthcare provider participating in the medical encounter and a routine for indicating the healthcare provider's identification in the patient's record.

16. The system of claim 14, further including a RFID card reader for transmitting the radiofrequency identification and medical encounter information.

17. The system of claim 16, wherein the RFID card reader is in a healthcare provider's office.

18. The system of claim 14, further comprising a telephone unit capable of transmitting the trans-telephonic transmitter identification and the medical encounter information.

19. The system of claim 18, wherein the telephone unit is in a healthcare provider's office. identification medical encounter

20. A business method for tracking medical encounters, comprising:
a. populating a database with at least one patient's record;
b. receiving notification of the patient's medical encounter with a healthcare provider;
c. updating the patient's record to add the date of the medical encounter and the identity of the healthcare provider; and
d. storing the updated record.

21. The business method of claim 20, further comprising reporting the date of the medical encounter and identity of the healthcare provider to the patient or to an authorized third party.

22. The business method of claim 20, wherein the patient is issued a device encoding a code identifying the patient in the database.

23. The business method of claim 22, wherein the device is selected from the group consisting of a trrans-telephonic transmitter, a radiofrequency card and a barcoded card.

24. The business method of claim 20, wherein notification is received via a telephone network.

25. The business method of claim 24, wherein notification is received through an interactive voice response system.
